(19) United States
(12) Patent Application Publication
(10) Pub. No.: US 2011/0249689 A1
(43) Pub. Date: Oct. 13, 2011

(54) DEVICES, SYSTEMS, AND METHODS PROVIDING MICRO-RING AND/OR MICRO-RACETRACK RESONATOR

(75) Inventors: Chee Wei Wong, New York, NY (US); Xiaodong Yang, New york, NY (US); James F. McMillan, New york, NY (US)

(73) Assignee: The Trustees of Columbia University in the City of New York, New York, NY (US)

(21) Appl. No.: 13/054,784

(22) PCT Filed: Jul. 20, 2009
(86) PCT No.: PCT/US09/51117

§ 371 Date: Jun. 15, 2011

Related U.S. Application Data
(60) Provisional application No. 61/081,863, filed on Jul. 18, 2008.

(51) Int. Cl. H01S 3/30; H01J 9/00

(52) U.S. Cl. 372/3; 445/23

(57) ABSTRACT

Provided herein are certain embodiments of systems, methods and devices for Raman lasers based on micro-ring and mircro-racetrack resonators, and the manufacturing thereof. For example, a device can be provided which is structured to receive an electro-magnetic radiation including a resonator arrangement which has a distance from one edge thereof to another edge thereof of at most approximately a wavelength of the electro-magnetic radiation that impacts the resonator arrangement. According to some embodiments, the resonator arrangement can be configured to generate a Raman radiation when impacted by a further electro-magnetic radiation. In some embodiments, the resonator arrangement can solely generate the Raman radiation which is lasing, which Raman radiation can be generated by the resonator arrangement in a continuous mode and/or a pulsed lasing mode. The resonator arrangement can generate the Raman radiation which is lasing without a use of an external electrical driver.

### CROSS-REFERENCE TO RELATED APPLICATION(S)

The present application claims priority from U.S. patent application No. 61/081,863, filed Jul. 18, 2008, the entire disclosure of which is hereby incorporated herein by reference in its entirety.

### STATEMENT REGARDING FEDERALLY SPONSORED RESEARCH

The present disclosure was developed, at least in part, using Government support under Grant No. 0622069 awarded by the National Science Foundation. Therefore, the Federal Government has certain rights in the present disclosure.

### FIELD OF THE DISCLOSURE

The present disclosure relates to, e.g., devices, systems and methods of providing and/or manufacturing Raman lasers based on micro-ring and micro-racetrack resonators, including Raman lasers.

### BACKGROUND INFORMATION

Generally, stimulated Raman scattering (“SRS”) has an extensive history since the development of the laser. Previously, the SRS effect at infrared frequencies has been established. This discovery was then described as a two-photon process with a full quantum mechanical calculation. To account for anti-Stokes generation and higher-order Raman effects, however, coupled-wave formalism was adopted to describe the stimulated Raman effect. Self-focusing was later included to account for the much larger gain observed in SRS. These understandings facilitated the study and design of Raman amplifiers and lasers. For example, low-threshold microcavity Raman lasers have been demonstrated in silica micro spheres and micro disks using excited whispering gallery modes (“WGMs”). Such devices can play an important role in the developing technology of photonic integrated circuits.

Because silicon is being considered as a possible platform for photonic integrated circuits, silicon-based photonic devices have been increasingly researched. Microscopic passive silicon photonic devices such as bends, splitters, and filters have been developed. Active functionalities in highly integrated silicon devices have been studied, such as optical bistability due to the nonlinear thermal-optical effect and fast all-optical switching with two-photon absorption.

Silicon-based Raman amplifiers and lasers also have been analyzed. The bulk Raman gain coefficient g_{R} in silicon is likely about 10₄ times higher than in silica. Light generation and amplification in planar silicon waveguides with Raman effects have been reviewed. Raman lasing using a silicon waveguide as the gain medium has been demonstrated, where the ring laser cavity is formed by, e.g., an 8-m-long optical fiber. A Raman laser using an S-shaped 4.8-cm-long silicon waveguide cavity with multi-layer coatings has also been reported, which can be integrated onto CMOS-compatible silicon chips.

There have been certain developments of tunable laser devices and methods of manufacturing such devices. For example, U.S. Patent Publication No. 2006/0050744 (the “744 Publication”), the entirety of the disclosure of which is explicitly incorporated by reference herein, describes various embodiments of a laser device that can include a layer of photonic crystal having a lattice of air-holes with defects that form an optical waveguide. According to some embodiments described the 744 Publication, the waveguide can have a cross-sectional area having dimensions in sub-wavelength ranges and which can be perpendicular to the propagation direction of light in the waveguide. In some embodiments described in the 744 Publication, the waveguide can pump light and output Stokes light through Raman scattering. The frequencies of the pump light and the Stokes light can include, e.g., slow group velocity modes of the pump light and Stokes light in the waveguide.

Further, there has been development of microscopic low-threshold Raman amplification and lasing devices on a monolithic silicon chip, which devices can support the development towards efficient, all-optical photonic integrated circuits. For example, U.S. Patent Publication No. 2007/0025409 (the “409 Publication”), the entirety of the disclosure of which is explicitly incorporated by reference herein, describes various embodiments of all-optical on-chip signal amplification and lasing. In particular, some embodiments of the 409 Publication implement Raman amplification and lasing devices using on-chip micro ring resonators coupled with waveguides in monolithic silicon. Some embodiments of the 409 Publication also include methods of manufacturing such devices. According to some embodiments of the 409 Publication, lasers can be designed with geometries so that WGM resonant frequencies of the micro ring resonator match the pump-Stokes frequency spacing of SRS in monolithic silicon. Therefore, in some embodiments of the 409 Publication, one or more pairs of pump and Stokes light can form WGMs in the micro ring resonator.

In the event of a conflict between the teachings of the application and those of the incorporated documents, the teachings of the application shall control.

Despite these advances, various improvements, such as, e.g., devices having a smaller waveguide and a high surface area to volume ratio leading to, e.g., a reduced carrier lifetime can be beneficial. Thus, it would be beneficial to reduce and/or eliminate the need for external biased voltage so as to reduce carrier lifetime.

### SUMMARY OF EMBODIMENTS OF THE PRESENT DISCLOSURE

Some embodiments of the present disclosure described herein include a device which is structured to receive at least one electro-magnetic radiation including at least one resonator arrangement which has a distance from one edge thereof to another edge thereof which is at most approximately a wavelength of the at least one electro-magnetic radiation that impacts the at least one resonator arrangement. The at least one resonator arrangement can be configured to generate a Raman radiation when impacted by a further electro-magnetic radiation, for example. In some embodiments, the at least one resonator arrangement can solely generate the Raman radiation which is lasing.

Certain embodiments of the Raman radiation which is lasing can be generated by the at least one resonator arrangement in a continuous mode and/or a pulsed lasing mode. In some embodiments, the at least one resonator arrangement can generate the Raman radiation which is lasing without a use of an external electrical driver. The external electrical driver can be a p-i-n diode arrangement, for example. According to some embodiments, the resonator arrangement(s) can have a carrier lifetime which is at most about 1 nanosecond. In some embodiments, the carrier lifetime can be at most about 0.5 nanosecond. The electro-magnetic radiation(s) can be applied to the resonator arrangement(s) so that carriers within the resonator arrangement(s) are purged at a surface of the at least one resonator arrangement, for example. According to some embodiments, the carriers can be completely purged immediately at a surface of the resonator arrangement(s).

In addition, provided herein are certain embodiments of a device according to the present disclosure which can be structured to receive at least one electro-magnetic radiation including at least one waveguide arrangement. Such exemplary waveguide arrangement(s) can have a width that is at most approximately a wavelength of the electro-magnetic radiation(s) that can impact the waveguide arrangement(s). The waveguide arrangement(s) can be configured to generate a Raman radiation when impacted by a further electro-magnetic radiation, for example. In some embodiments, the waveguide arrangement(s) can include at least one photonic crystal arrangement, which can be structured to produce the Raman radiation at a slow-group velocity of a propagation of at least one of the Raman radiation or the at least one elector-magnetic radiation, for example. The resonator arrangement(s) can have a first portion extending along one axis, and a second portion which has at least (i) a first section which extends parallel to the first portion, and (ii) a second section which is distanced further from the first portion than the first section.

In addition, described herein are certain embodiments of methods and/or procedures according to the present disclosure for manufacturing a lasing device, which can include, e.g., providing a silicon micro-ring with a predetermined radius and a predetermined first cross-sectional dimension; creating a silicon waveguide with a predetermined second cross-sectional dimension; and disposing the silicon micro-ring from the silicon waveguide at a predetermined distance. The predetermined distance, radius, first cross-sectional dimension, and second cross-sectional dimension can be configured so that at least one first whispering gallery mode resonant frequency of the silicon micro-ring and at least one second whispering gallery mode resonant frequency of the silicon micro-ring can be separated by an optical phonon frequency of silicon, for example. In some embodiments, the lasing device can include at least one resonator arrangement which has a distance from one edge thereof to another edge thereof which is at most approximately a wavelength of at least one electro-magnetic radiation that impacts the at least one resonator arrangement. The resonator arrangement(s) can be configured to generate a Raman radiation when impacted by a further electro-magnetic radiation, for example.

According to some embodiments, the cross-sectional dimension of the silicon waveguide and a surface area to volume ratio can be configured to provide a reduced carrier lifetime. For example, the cross-sectional dimension of the silicon waveguide can have a submicron meter width and a submicron meter height. Embodiments of methods and/or procedures according to the present disclosure can further include displaying and/or storing information associated with the lasing device, manufacturing the lasing device and/or using the lasing device in a storage arrangement in a user-accessible format and/or a user-readable format.

A method for manufacturing a lasing device having a silicon micro-ring coupled with a silicon waveguide in accordance with another embodiment of the present disclosure is also described herein. Some embodiments of such methods can include, e.g., determining (i) a radius and a first cross-sectional dimension of the silicon micro-ring, (ii) a second cross-sectional dimension of the silicon waveguide, and (iii) a distance between the silicon micro-ring and the silicon waveguide, so that at least one first whispering gallery mode resonant frequency of the silicon micro-ring and at least one second whispering gallery mode resonant frequency of the silicon micro-ring are separated by an optical phonon frequency of silicon. Some embodiments can further include, e.g., creating the silicon micro-ring with the determined radius and the determined first cross-sectional dimension, creating the silicon waveguide with the determined second cross-sectional dimension, and disposing the silicon micro-ring from the silicon waveguide at the determined distance.

These and other objects, features and advantages of the present invention will become apparent upon reading the following detailed description of exemplary embodiments of the present disclosure, when taken in conjunction with the appended claims.

### BRIEF DESCRIPTION OF THE DRAWINGS

Further objects, features and advantages provided by the present disclosure will become apparent from the following detailed description taken in conjunction with the accompanying figures showing illustrative embodiments, in which:

FIG. 1(a) is a silicon waveguide cross-section of a micro-racetrack in accordance with some embodiments of the present disclosure, FIG. 1(b) is a top view of the micro-racetrack shown in FIG. 1(a), and FIG. 1(c) is a detailed top view of a particular portion of the micro-racetrack shown in FIG. 1(b);

FIG. 2 is a graph providing a continuous-wave Raman lasing input-output characteristics of micro-racetrack and micro-ring resonators for different parameters in accordance with certain embodiments of the present disclosure;

FIGS. 3(a) and 3(b) are graphs illustrating enhancement of spontaneous Raman scattering in a micro-racetrack resonator in accordance with certain embodiments of the present disclosure;

FIG. 4 is a flow diagram of a procedure for providing or manufacturing a lasing device in accordance with certain embodiments of the present disclosure which can be executed by a processing arrangement;

FIG. 5 is a flow diagram of another procedure for providing or manufacturing a lasing device in accordance with some embodiments of the present disclosure which can be executed by the processing arrangement; and

FIG. 6 is a block diagram of a system or an arrangement configured in accordance with a certain embodiment of the present disclosure.

Throughout the figures, the same reference numerals and characters, unless otherwise stated, are used to denote like features, elements, components or portions of the illustrated embodiments. Moreover, while the present disclosure will now be described in detail with reference to the accompanying figures, it is done so in connection with the illustrative embodiments. It is intended that changes and modifications can be made to the described embodiments without departing from the true scope and spirit of the present disclosure.

### DETAILED DESCRIPTION OF EMBODIMENTS

Provided and described herein are, e.g., devices, systems and methods of manufacturing Raman lasers based on micro-ring and micro-racetrack resonators. Some embodiments in accordance with the present disclosure provide, e.g., devices and methods of manufacturing all-silicon Raman lasers based on micro-ring and micro-racetrack resonators.

### Examples of Lasing Devices According to Certain Embodiments of the Present Disclosure

According to some embodiments of the present disclosure, a device for generating a laser beam can be provided. For example, certain embodiments of the device can include, e.g., a silicon micro-ring having a radius and a first cross-sectional dimension; and a silicon waveguide having a second cross-sectional dimension. The waveguide can be disposed at a predetermined distance from the exemplary micro-ring. The distance, the radius, the first cross-sectional dimension, and the second cross-sectional dimension can be configured and/or arranged so that at least one first whispering gallery mode resonant frequency of the silicon micro-ring and at least one second whispering gallery mode resonant frequency of the silicon micro-ring are separated by an optical phonon frequency of silicon.

According to some embodiments of the present disclosure, a device for generating a laser beam is provided that can include, e.g., a layer of photonic crystal having a lattice of air-holes with defects that form an optical waveguide with a cross-sectional area having dimensions in sub-wavelength ranges. The cross-sectional area can be perpendicular to the propagation direction of the electro-magnetic radiation (e.g., light) in the waveguide. The waveguide can receive pump light and output Stokes light through Raman scattering.

Some embodiments according to the present disclosure also provide a device for generating a laser beam that can include, e.g., a photonic crystal made from silicon that can have air-holes forming a pair of optically coupled cavities having geometries that can be substantially the same to one another. The cavities can be defined to cause a frequency-splitting difference between a frequency of pump light and a frequency of Stokes light to correspond to an optical phonon frequency in silicon through Raman scattering, for example.

According to further embodiments of the present disclosure, a device for generating a laser beam is provided that can include, e.g., a layer of photonic crystal having a lattice of air-holes and at least one cavity formed by defects in the lattice of air-holes. The cavity can have a surface area on a surface of the layer. The dimensions of the surface area can be in the range of, e.g., several micro-meters. The cavity can output Stokes light in response to pump light through Raman scattering, for example.

In some embodiments of a device in accordance with the present disclosure, including some of those devices described herein for example, the cross-sectional dimension of the waveguide can be small and the surface area to volume ratio can be high, which can lead to a reduced carrier lifetime. Thus, a need for external biased voltage to reduce carrier lifetime can be eliminated, for example. The cross-sectional dimension of the waveguide can have a submicron meter width and height. For example, the width can be within a range of, e.g., approximately 0.1 μm to approximately 0.9 μm, such as, e.g., approximately 0.45 μm. The height can also be within the range of, e.g., approximately 0.1 μm to approximately 0.9 μm, such, e.g., as approximately 0.25 μm, for example.

Some embodiments of the device can provide a relatively low-threshold continuous-wave Raman silicon laser based on a 3-centimeter-long racetrack cavity. For example, the micrometer-size rib waveguide can have an effective modal area of 1.6 μm2. A p-i-n diode structure can be used to, e.g., minimize nonlinear losses due to two-photon absorption (TPA) induced free-carrier absorption (FCA) and achieve low lasing threshold, for example. By reverse-biasing the diode with a voltage of, e.g., 10 to 20 volts, such as 25 volts, the effective free carrier lifetime τ_{fc} can be reduced from, e.g., 10 to 20 nanoseconds, such as, 15 nanoseconds to, e.g., 0.1 to 0.9 nanoseconds, such as to below 0.4 nanoseconds, for example.

Micro-ring and micro-racetrack resonators used in accordance with the present disclosure can have cross section dimensions of, e.g., 0.45 μm (W) by 0.25 μm (H), with an effective modal area of approximately 0.1 μm², which can be more than 10 times smaller in comparison to other embodiments, such as those described herein. The τfc can be significantly reduced to a level below 1 nanosecond, such as, e.g., approximately 0.5 nanoseconds for micro-ring resonators. Such embodiments can provide the device to lase, e.g., without introducing an external p-i-n diode to drive the carriers away, for example. According to embodiments with a micro-ring having a diameter of 10 μm, the effective modal volume can be, e.g., approximately 7 μm³. According to further embodiments with, e.g., a 3-mm-long micro-racetrack, the effective modal volume can be, e.g., approximately 2000 μm³, for example.

### Examples of Spontaneous Emission Enhancement of Raman Scattering in Micro-Racetracks

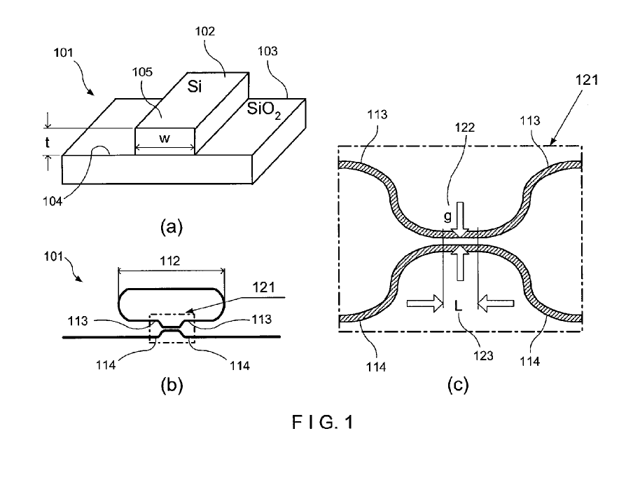

FIGS. 1(a)-1(c) illustrate various views of a cross-section of a device 101 according to certain embodiments of the present disclosure that has been configured and arranged to provide enhancement of spontaneous emission, for lasing, in micro-racetracks. As shown in FIG. 1(a), the device 101 can have a first portion (Si) 102, a second portion (SiO₂) 103, a waveguide thickness (t) 104 and width (w) 105. According to certain embodiments, the waveguide thickness (t) 104 can be in the range of, e.g., approximately 100 to 900 nanometers, such as, e.g., approximately 250nanometers; and the width (w) can also be in the range of, e.g., approximately 100 to 900 nanometers, such as, e.g., approximately 400 nanometers, for example.

FIG. 1(b) illustrates a micro-racetrack 111 of the device 101 and FIG. 1(c) shows an enlargement of area 121 of a particular portion of the micro-racetrack 111. As shown in FIGS. 1(b) and 1(c), the micro-racetrack 111 can have a length 112, a first portion 113, a second portion 114, a coupling gap (g) 122 and a coupling length (L) 123. For example, the length of the micro-racetrack resonator can be in the range of, e.g., approximately 1 millimeter to 6 approximately millimeters, such as, e.g., approximately 3 millimeters. The coupling gap (g) can be in the range of, e.g., approximately 100 nanometers to approximately 300 nanometers, such as, e.g., approximately 170 nanometers. The coupling length (L) can be in the range of, e.g., approximately 1 μm to approximately 30 μm, such as, e.g., approximately 10 μm, for example.

According to certain embodiments, a low power tunable laser source which can include the device 101 can be amplified using an erbium doped fiber amplifier to be used as the Raman pump. Such exemplary amplification can be to a power in the range of, e.g., approximately 200 mW to approximately 500 mW, such as, e.g., approximately 250 mW. For example, the pump can be coupled into the resonator using a tapered lensed fiber, for example. The transmitted pump and the emitted Stokes can be coupled to the resonator using, e.g., a similar lensed fiber. A wavelength division multiplexer can then be used to separate the pump wavelength from the Stokes wavelength. Both the pump and the emitted stokes can be measured using, e.g., a photo detector. For example, the waveguide loss can be in the range of, e.g., approximately 2 dB/cm to approximately, 4 dB/cm, such as approximately 3 dB/cm. The coupling loss can be in the range of, e.g., approximately 6 dB to approximately 10 dB, such as, e.g., approximately 8 dB. Thus, for example, a coupled input power in the range of, e.g., approximately 30 mW to approximately 50 mW, such as, e.g., approximately 40 mW, can be provided in accordance with some embodiments of the present disclosure.

### Examples of Coupled-Mode Theory Analysis of Continuous Wave Raman Lasing in Silicon Micro-Ring and Micro-Racetrack Resonators

Further described herein are examples of lasing characteristics analysis procedure according to certain exemplary embodiment of the present disclosure for silicon Raman lasers based on micro-ring and micro-racetrack resonators using a coupled-mode theory (CMT) model or procedure. Other embodiments can include, for example, data relating to a spontaneous emission enhancement of Raman scattering in micro-racetrack resonators, for example.

For example, according to certain embodiments of the present disclosure, lasing input-output characteristics and lasing a threshold can be analyzed and determined by using a coupled-mode theory framework. Loss rates of cavity modes due to, e.g., radiation, linear material absorption, two-photon absorption and free-carrier absorption can be included in the CMT model. A refractive index shift from, e.g., Kerr effect, free-carrier dispersion and thermal dispersion can also be considered in some embodiments. Equations in accordance with certain embodiments of the present disclosure can be numerically integrated to, e.g., describe the dynamical behavior of pump-Stokes interactions in micro-ring and micro-racetrack resonators that can support two-mode frequencies of, e.g., 15.6 THz, which can be desired in some embodiments of the present disclosure.

Raman lasing in silica-based high-Q whispering gallery mode resonators, such as, e.g., microspheres, microdisks and microtoroids, can have relatively low and/or ultralow lasing thresholds. In addition, continuous-wave silicon Raman lasers can have centimeter-size waveguide cavities and racetrack cavities with significantly reduced free carrier lifetime. According to certain embodiments of the present disclosure, a reverse-biased p-i-n diode embedded in a silicon waveguide can be used. The bulk Raman gain coefficient g_{R} can be, e.g., 10³ to 10⁴ times larger in silicon than in silica, for example. The enhanced stimulated Raman amplification and relatively low and/or ultralow threshold Raman lasing in high-Q/Vₘ photonic crystal nanocavities and slow-light photonic crystal waveguides can be used. According to some embodiments according to the present disclosure, Raman lasers can be provided which can be based on micrometer-size whispering gallery mode resonators such as, e.g., micro-ring and micro-racetrack configurations that can reduce free carrier lifetime and achieve Raman lasing without an external p-i-n diode for driving the free carrier away.

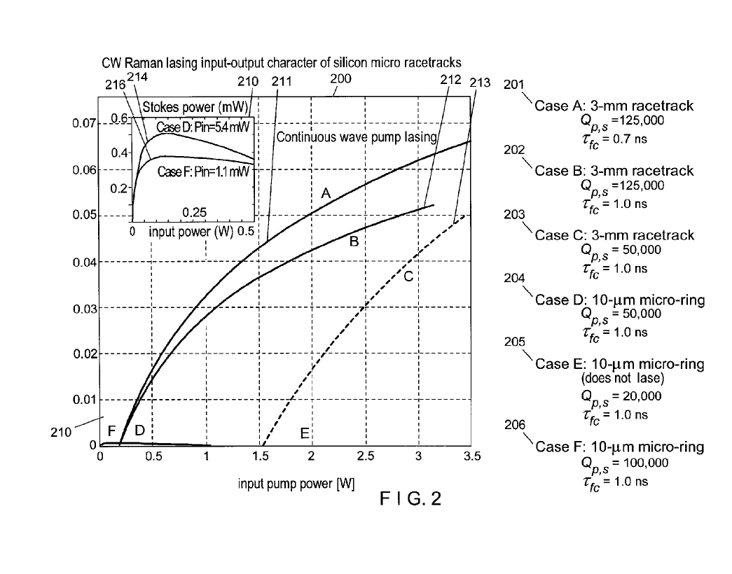

FIG. 2 shows an exemplary graph of continuous-wave Raman lasing input-output characteristics of micro-racetrack and micro-ring resonators having different parameters in accordance with some embodiments of the present disclosure. As depicted in FIG. 2, for example, the curves associated with Case A 201, Case B 202 and Case C 203 provide exemplary characteristics of a 3-mm-long micro-racetrack Raman laser that can have different quality factors Q and different τ_{fc}. As shown in FIG. 2, e.g., Case A 201 and Case B 202 can have the same Q_{p,s}, and a τ_{fc} that is different from that of the other. According to the example depicted in FIG. 2, Case A 201 and Case B 202 have the same Q_{p,s}, of 125,000 and a τ_{fc} of 0.7 nanoseconds and 1.0 nanoseconds, respectively. The graph 200 of FIG. 2 by line A 211 and line B 212 shows that a longer τ_{fc} can provide a higher lasing threshold of, e.g., approximately 200 mW, and a lower conversion efficiency, for example. In addition, FIG. 2 shows that Case B 202 and Case C 203 can have the same τ_{fc} and a different quality factor Q_{p,s}, from one another. According to the example illustrated in FIG. 2 by line B 212 and line C 213, a lower Q_{p,s}, can result in a larger lasing threshold of, e.g., approximately 1.5 W.

As also shown in FIG. 2, for example, the curves associated with Case D 204, Case E 205 and Case F 206 provide characteristics of a 10-μm-diameter micro-ring Raman laser for various Q_{p,s}. In this example, the Q_{p,s}, for Case E 205 can be too low for the optical gain to overcome the loss, resulting in there being no lasing. When the Q_{p,s} is higher, such as, e.g., 50,000 or 100,000, as for Case D 204 and Case F 206, respectively, the Raman gain can be greater than the loss, resulting in there being lasing behavior, as shown by line D 214 and line F 216. The calculated or determined lasing threshold in this example, is, e.g., 5.4 mW and 1.1 mW for Case D 204 and Case F 206, respectively.

In order to determine the effect that a resonator according to certain embodiments of the present disclosure can have on an emitted Stokes intensity, a pump laser wavelength can be scanned through multiple free-spectral ranges while the emitted stokes power and transmitted pump power is recorded. This exemplary information and/or data can be stored on, e.g., a computer-readable medium and/or computer-accessible medium that can be part of, e.g., a computing arrangement and/or processing arrangement, which can include and/or be interfaced with computer-accessible medium having executable instructions thereon that can be executed by the computing arrangement and/or processing arrangement. These arrangements can include and/or be interfaced with, but not limited to) a storage arrangement, which can be or include memory such as, e.g., RAM, ROM, cache, CD ROM, etc., a user-accessible and/or user-readable display, and user input devices, a communication module and other hardware components forming a system to, e.g., design, provide and/or manufacture a lasing device in accordance with certain embodiments of the present disclosure, and/or analyze information and/or data associated with the device and/or a method of manufacturing and/or using the device accordance with certain embodiments of the present disclosure, for example.

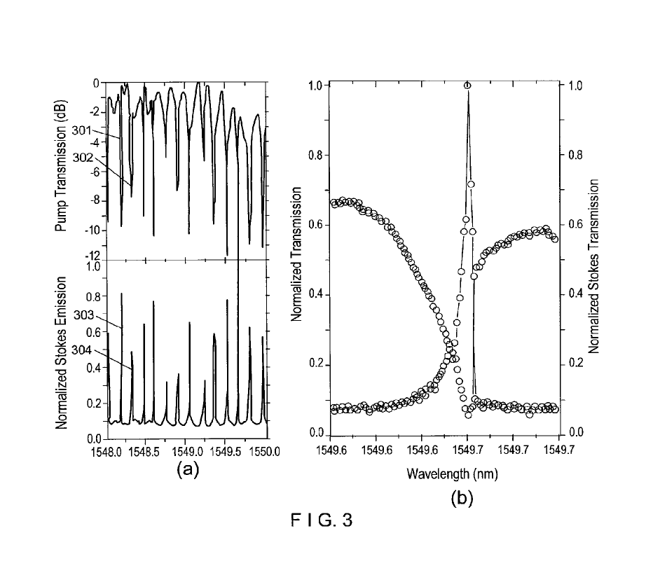

For example, FIGS. 3(a) and 3(b) illustrate graphs providing exemplary results of enhancement of spontaneous Raman scattering in a micro-racetrack resonator in accordance with certain embodiments of the present disclosure. As shown in FIG. 3(a), when the pump is “on-resonance” with the micro-racetrack resonator, as illustrated by a dip in the transmission spectrum, such as dips 301 and 302, the Stokes intensity can increase extensively above the off-resonance wavelengths, illustrated as peaks 303 and 304, for example. The existence of Stokes energy in the off-resonance condition illustrated in FIG. 3(a) is due the Stokes emission generated by the resonator coupling waveguide.

For the exemplary resonance shown in the graph of FIG. 3(b), at λ_{R}=1549.7, for example, the quality factor Q can be approximately 120,000. The resulting enhancement of the Stokes emission, above the off resonance condition, can be about 14 times. This exemplary enhancement can be increased to provide for lasing if the resonator is structured and/or arranged so that the parameters of the resonator, such as g 122 and L 123 of FIG. 1(c), are sized and/or dimensioned to improve coupling to the resonator, for example.

### Examples of Method of Manufacturing an Exemplary Lasing Device

A method of manufacturing a lasing device can be provided according to certain embodiments of the present disclosure. For example, a summary of such exemplary method can be as follows:

1) create and/or provide a silicon micro-ring with a predetermined radius and a predetermined first cross-sectional dimension;

2) create and/or provide a silicon waveguide with a predetermined second cross-sectional dimension; and

3) dispose, provide or arrange the silicon micro-ring from the silicon waveguide at a predetermined distance.

According to certain embodiments of the present disclosure, the predetermined distance, the predetermined radius, the predetermined first cross-sectional dimension, and the predetermined second cross-sectional dimension can be determined and/or configured so that, e.g., at least one first whispering gallery mode resonant frequency of the silicon micro-ring and at least one second whispering gallery mode resonant frequency of the silicon micro-ring are separated by an optical phonon frequency of silicon, for example.

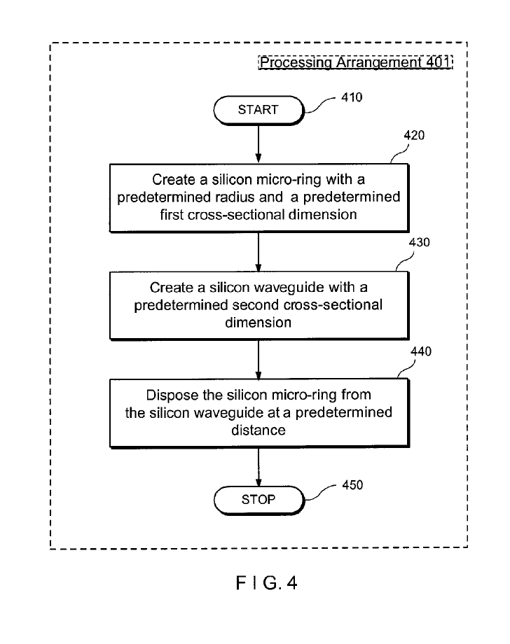

For example, FIG. 4 illustrates a flow diagram of such exemplary procedure for providing and/or manufacturing a lasing device in accordance with certain embodiments of the present disclosure. As shown in FIG. 4, the exemplary procedure can be executed on and/or by or under the control of a processing arrangement 401 (e.g., one or more micro-processors or a collection thereof). The procedure starts at step 410. Then, the exemplary procedure can create and/or provide a silicon micro-ring with a predetermined radius and a predetermined first cross-sectional dimension—step 420. In step 430, the procedure can then create and/or produce a silicon waveguide with a predetermined second cross-sectional dimension. The procedure can then, in step 440, dispose the silicon micro-ring from the silicon waveguide at a predetermined distance.

Further, a method of manufacturing a lasing device having a silicon micro-ring coupled with a silicon waveguide according to certain other embodiments of the present disclosure can be provided. For example, a summary of such exemplary method can be as follows:

1) determine (i) a radius and a first cross-sectional dimension of the silicon micro-ring, (ii) a second cross-sectional dimension of the silicon waveguide, and (iii) a distance between the silicon micro-ring and the silicon waveguide, so that at least one first whispering gallery mode resonant frequency of the silicon micro-ring and at least one second whispering gallery mode resonant frequency of the silicon micro-ring are separated by an optical phonon frequency of silicon;

2) create and/or provide the silicon micro-ring with the determined radius and the determined first cross-sectional dimension;

3) create and/or provide the silicon waveguide with the determined second cross-sectional dimension; and

4) dispose, provide or arrange the silicon micro-ring from the silicon waveguide at the determined distance.

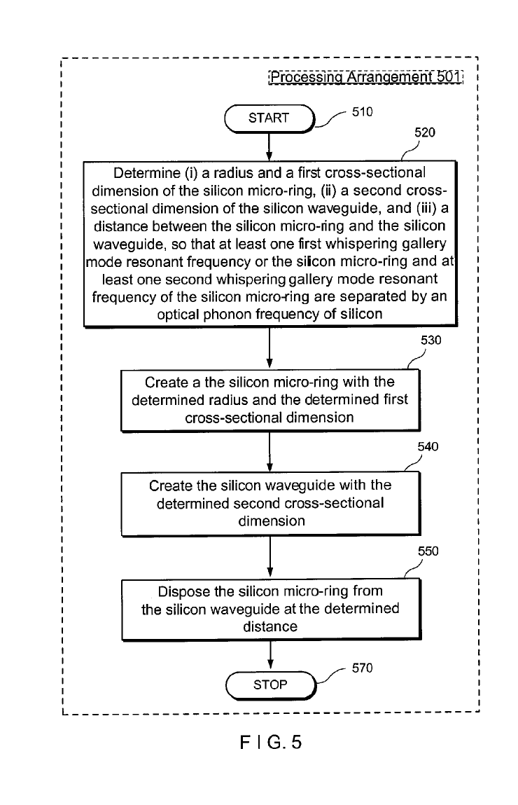

For example, FIG. 5 illustrates a flow diagram of such exemplary procedure for manufacturing a lasing device in accordance with some embodiments of the present disclosure. As shown in FIG. 5, the procedure can be executed on and/or by or under the control of a processing arrangement 501 (e.g., one or more micro-processors or a collection thereof). The procedure starts at step 510. Then, in step 520, the exemplary procedure can determine (i) a radius and a first cross-sectional dimension of the silicon micro-ring, (ii) a second cross-sectional dimension of the silicon waveguide, and (iii) a distance between the silicon micro-ring and the silicon waveguide, so that at least one first whispering gallery mode resonant frequency of the silicon micro-ring and at least one second whispering gallery mode resonant frequency of the silicon micro-ring are separated by an optical phonon frequency of silicon. In step 430, the procedure can create and/or provide the silicon micro-ring with the determined radius and the determined first cross-sectional dimension. The procedure can then, in step 540, create and/or provide the silicon waveguide with the determined second cross-sectional dimension. In step 550, the procedure can dispose, provide or arrange the silicon micro-ring from the silicon waveguide at the determined distance. Other embodiments of procedures are described herein.

For example, additional embodiments of the present disclosure provide another method of manufacturing a laser device. A summary of such exemplary method includes the following procedure:

1) form or provide a layer of silicon; and

2) etch the silicon layer to form photonic crystal having a lattice of air-holes with defects that form an optical waveguide having a cross-sectional area with dimensions that are in sub-wavelength ranges.

For example, the cross-sectional area of the waveguide can be perpendicular to the propagation direction of light in the waveguide, which can receive pump light and output Stokes light through Raman scattering, for example.

In addition, a further method of manufacturing a laser device according to certain exemplary embodiments of the present disclosure can be provided that can include the following procedure:

1) form or provide a layer of silicon; and

2) etch the silicon layer to form a photonic crystal having air-holes and to form a pair of optically coupled cavities having geometries that are substantially identical to one another.

The cavities can be defined to cause a frequency-splitting difference between a frequency of pump light and a frequency of Stokes light to correspond to an optical phonon frequency in silicon through Raman scattering, for example.

Still another method of manufacturing a laser device according to certain exemplary embodiments of the present disclosure can be provided that includes the following procedures:

1) form and/or provide a silicon layer; and

2) etch the silicon layer to form photonic crystal having a lattice of air-holes; and forming at least one cavity shaped by defects in the lattice of air-holes.

The cavity can have a surface area on a surface of the layer. According to some embodiments, the dimensions of the surface area can be within several micro-meter ranges. The cavity can output Stokes light in response to pump light through Raman scattering, for example.

In some embodiments of the device manufactured by the exemplary method in accordance with the present disclosure, including one or more of the exemplary methods described herein, for example, the cross-sectional dimension of the waveguide can be small and the surface area to volume ratio can be high, which can lead to a reduced carrier lifetime. Thus, it is possible to reduce or even eliminate the need for an external biased voltage to reduce carrier lifetime, for example. The cross-sectional dimension of the waveguide can have a submicron meter width and height. For example, the width can be within a range of, e.g., approximately 0.1 μm to approximately 0.9 μm, such as, e.g., approximately 0.45 μm. The height can also be within the range of, e.g., approximately 0.1 μm to approximately 0.9 μm, such, e.g., as approximately 0.25 μm, for example.

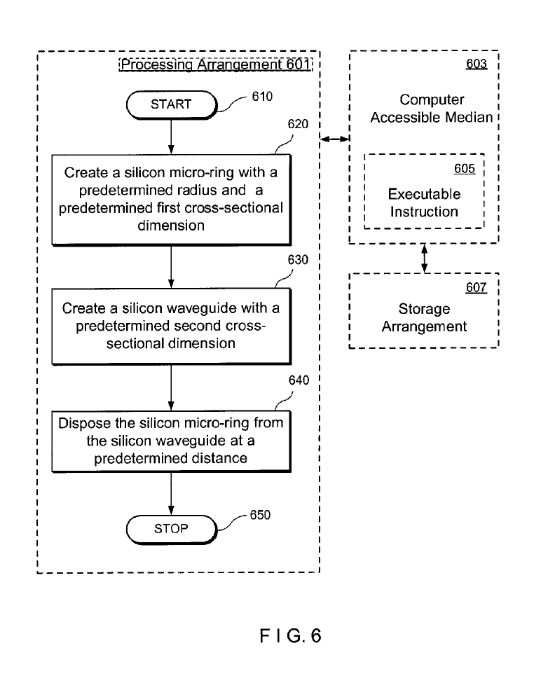

FIG. 6 shows a combination of a block diagram and functional diagram of a system and/or arrangement configured in accordance with some embodiments of the present disclosure for manufacturing and/or providing the lasing device, for example. As shown in FIG. 6, e.g., a computer-accessible medium 603 (e.g., as described herein above, storage device such as hard disk, floppy disk, memory stick, CD-ROM, RAM, ROM, etc., or a collection thereof) can be provided (in communication with the processing arrangement 601, which can be one or more computers) The computer-accessible medium 603 can contain executable instructions 605 thereon. For example, when the processing arrangement 601 accesses the computer-accessible medium 603, retrieves executable instructions 605 therefrom and then executes the executable instructions 605, the processing arrangement 601 can be configured or programmed to create and/or provide a silicon micro-ring with a predetermined radius and a predetermined first cross-sectional dimension in block 620, and, in block 630, create and/or provide a silicon waveguide with a predetermined second cross-sectional dimension. Further, in block 640, the processing arrangement 601, based on the executable instructions 605, can be configured to dispose the silicon micro-ring from the silicon waveguide at a predetermined distance. In addition or alternatively, a software arrangement 607 can be provided separately from the computer-accessible medium 603, which can provide the instructions to the processing arrangement 601 so as to configure the processing arrangement 601 to execute the procedures 610-640, as described herein above.

Some embodiments in accordance with the present disclosure, can including some of those described herein, can be combined with the subject matter disclosed in the 744 Publication and/or the 409 Publication, the entirety of the disclosures of which have been explicitly incorporated by reference herein, and thus shall be considered as part of the present disclosure and application.

Additionally, embodiments of computer-accessible medium described herein can have stored thereon computer executable instructions for designing, manufacturing and/or using a lasing device in accordance with the present disclosure. In addition, such computer-accessible medium can be any available media that can be accessed by a general purpose or special purpose computer. By way of example, and not limitation, and as indicated to some extent herein above, such computer-accessible medium can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications link or connection (either hardwired, wireless, or a combination of hardwired or wireless) to a computer, the computer properly views the connection as a computer-accessible medium. Thus, any such a connection is properly termed a computer-accessible medium. Combinations of the above should also be included within the scope of computer-accessible medium.

Computer-executable instructions can include, for example, instructions and data which cause a general purpose computer, special purpose computer, or special purpose processing device or other devices (e.g., mobile phone, personal digital assistant, etc.) with embedded computational modules or the like configured to perform a certain function or group of functions.

Those having ordinary skill in the art will appreciate that embodiments according to the present disclosure can be practiced with network computing environments with many types of computer system configurations, including personal computers, hand-held devices, multi-processor systems, microprocessor-based or programmable electronics and devices, network PCs, minicomputers, mainframe computers, and the like. Embodiments in accordance with the present disclosure can also be practiced in distributed computing environments where tasks are performed by local and remote processing devices that are linked (either by, e.g., hardwired links, wireless links, or a combination of hardwired and wireless links) through a communications network. In a distributed computing environment, program modules can be located in both local and remote memory storage devices.

The foregoing merely illustrates the principles of the present disclosure. Various modifications and alterations to the described embodiments will be apparent to those having ordinary skill in the art in view of the teachings herein. It will thus be appreciated that those having ordinary skill in the art will be able to devise numerous devices, systems, arrangements, computer-accessible medium and methods which, although not explicitly shown or described herein, embody the principles of the present disclosure and are thus within the spirit and scope of the present disclosure. As one having ordinary skill in the art shall appreciate, the dimensions, sizes and other values described herein are examples of approximate dimensions, sizes and other values. Other dimensions, sizes and values, including the ranges thereof, are possible in accordance with the present disclosure.

It will further be appreciated by those having ordinary skill in the art that, in general, terms used herein, and especially in the appended claims, are generally intended as open. In addition, to the extent that the prior art knowledge has not been explicitly incorporated by reference herein above, it is explicitly being incorporated herein in its entirety. All publications referenced above are incorporated herein by reference in their entireties. In the event of a conflict between the teachings of the application and those of the incorporated documents, the teachings of the application shall control.

What is claimed is:

1. A device which is structured to receive at least one electro-magnetic radiation, comprising:
at least one resonator arrangement which has a distance from one edge thereof to another edge thereof which is at most approximately a wavelength of the at least one electro-magnetic radiation that impacts the at least one resonator arrangement, wherein the at least one resonator arrangement generates a Raman radiation when impacted by a further electro-magnetic radiation.

2. The device according to claim 1, wherein the at least one resonator arrangement solely generates the Raman radiation which is lasing.

3. The device according to claim 2, wherein the Raman radiation which is lasing is generated by the at least one resonator arrangement in at least one of a continuous mode or a pulsed lasing mode.

4. The device according to claim 1, wherein the at least one resonator arrangement generates the Raman radiation which is lasing without a use of an external electrical driver.

5. The device according to claim 4, wherein the external electrical driver is a p-i-n diode arrangement.

6. The device according to claim 1, wherein the at least one resonator arrangement has a carrier lifetime which is at most about 1 nanosecond.

7. The device according to claim 6, wherein the carrier lifetime is at most about 0.5 nanosecond.

8. The device according to claim 1, wherein, when the at least one electro-magnetic radiation is applied to the at least one resonator arrangement carriers within the at least one resonator arrangement are completely purged immediately at a surface of the at least one resonator arrangement.

9. The device according to claim 1, wherein the at least one resonator arrangement has a first portion extending along one axis, and a second portion which has at least (i) a first section which extends parallel to the first portion, and (ii) a second section which is distanced further from the first portion than the first section.

10. A device which is structured to receive at least one electro-magnetic radiation, comprising:
at least one waveguide arrangement which has a width that is at most approximately a wavelength of the at least one electo-magnetic radiation that impacts the at least one waveguide arrangement, wherein the at least one waveguide arrangement generates a Raman radiation when impacted by a further electro-magnetic radiation.

11. The device according to claim 10, wherein the at least one waveguide arrangement includes at least one photonic crystal arrangement.

12. The device according to claim 10, wherein the at least one photonic crystal arrangement is structured to produce the Raman radiation at a slow-group velocity of a propagation of at least one of the Raman radiation or the at least one elector-magnetic radiation.

13. The device according to claim 10, wherein the at least one resonator arrangement has a first portion extending along one axis, and a second portion which has at least (i) a first section which extends parallel to the first portion, and (ii) a second section which is distanced further from the first portion than the first section.

14. A method for providing a lasing device, comprising:
a) providing a silicon micro-ring with a predetermined first cross-sectional dimension;
b) providing a silicon waveguide with a predetermined second cross-sectional dimension; and
b) disposing the silicon micro-ring from the silicon waveguide at a predetermined distance.

15. The method according to claim 14, wherein the predetermined distance, the predetermined first cross-sectional dimension, and the predetermined second cross-sectional dimension are configured such that at least one first whispering gallery mode resonant frequency of the silicon micro-ring and at least one second whispering gallery mode resonant frequency of the silicon micro-ring are separated by an optical phonon frequency of silicon.

16. The method according to claim 14, wherein the lasing device includes at least one resonator arrangement which has a distance from one edge thereof to another edge thereof which is at most approximately a wavelength of at least one electro-magnetic radiation that impacts the at least one resonator arrangement.

17. The method according to claim 16, wherein the at least one resonator arrangement is configured to generate a Raman radiation when impacted by a further electro-magnetic radiation.

18. The method according to claim 14, wherein the cross-sectional dimension of the silicon waveguide and a surface area to volume ratio are configured to provide a reduced carrier lifetime.

19. The method according to claim 14, wherein the cross-sectional dimension of the silicon waveguide has a submicron meter width and a submicron meter height.

20. The method according to claim 14, further comprising at least one of displaying or storing information associated with the at least one of the lasing device, manufacturing the lasing device or using the lasing device in a storage arrangement in at least one of a user-accessible format or a user-readable format.
